(19) United States
(12) Patent Application Publication
(10) Pub. No.: US 2013/0009989 A1
(43) Pub. Date: Jan. 10, 2013

(54) METHODS AND SYSTEMS FOR IMAGE SEGMENTATION AND RELATED APPLICATIONS

(76) Inventors: Li-Hui Chen, Taoyuan County (TW); Chun-Hsiang Huang, Taoyuan County (TW); Tai-Ling Lu, Taoyuan-County (TW); Hao-Yuan Chen, Taoyuan County (TW)

(21) Appl. No.: 13/416,165

(22) Filed: Mar. 9, 2012

Related U.S. Application Data
(60) Provisional application No. 61/505,298, filed on Jul. 7, 2011.

(51) Int. Cl. G09G 5/00; G06F 3/041

(52) U.S. Cl. 345/629

(57) ABSTRACT

The invention provides methods and systems for image segmentation and related application in a portable device. Movements of a input tool on an image is detected for determining a region to be segmented from the image. When image segmentation is done, segmented region can be applied with various visual effects. For example, background can be replaced with a plurality of other different images.

### BACKGROUND

1. Field of the Invention

The invention relates generally to image segmentation, more particularly to methods and systems for segmenting foreground and background of an image and related applications.

2. Description of the Related Art

Recently, portable devices, such as handheld devices, have become more and more technically advanced and multifunctional. For example, a handheld device may have telecommunications capabilities, e-mail/message capabilities, advanced contact management, media playback, and various other functions. Due to increased convenience and functions of the devices, these devices have become necessities of life.

Generally, a handheld device can provide various functions which are implemented as widgets, applications, virtual or physical buttons, or any other kind of executable program code. Due to the size limitation of screen or other requirements, only limited numbers of interfaces, such as menus or pages can be provided on the screen of the handheld device. Users can perform a switch operation to switch between the interfaces by using a virtual or physical key, or a touch-sensitive screen.

In some applications, foreground and background of an image can be automatically segmented. In a conventional implementation, foreground and background segmentation is achieved by comparing the color variances of pixels located around the edge of a contour. The contour may define an edge of an object, and the object is identified by other techniques, for example face recognition. Another conventional implementation is to compare two images of the same scene but having different focus. Normally, the foreground is more focused than background. By computing the difference, the foreground or background can be determined. In order to achieve such post processing, complex and massive calculation is required. This may be time consuming and occupy computation resources.

### SUMMARY

Methods and systems for segmenting foreground and background of an image, displaying interfaces, and related applications are provided.

In one embodiment the invention provides a method for image segmentation applied in a portable device having a touch display unit. The method comprises obtaining an image, displaying the image on the touch display unit, detecting a movement of an input tool on the touch display unit, and determining a designated zone within the image corresponding to the movement, and segmenting the image according to the designated zone to obtain at least one segmented region. Furthermore, the at least one segmented region corresponds to foreground or background of the image.

In another embodiment of the invention provides a system for executing an image segmentation application in a portable device. The system comprises a touch display unit configured to display an image and to receive at least one user input corresponding to the image, a storage unit configured to store the image, a processing unit configured to execute the image segmentation application according to the at least one user input. The image segmentation application performs determination of a designated zone within the image according to the user input, image segmentation to obtain a segmented region corresponding to the designated zone, and a visual effect on the image with respect to the segmented region. The system optionally comprises an image capture unit capture the image according to the user input and store the image along with parameters corresponding to the input.

In yet another embodiment of the invention a method for image segmentation applied in a portable device is provided. The method comprises displaying an image and receiving at least one user input from a touch display unit, performing an image segmentation on the image according to the at least one user input, and applying a visual effect on the image according to the result of the image segmentation, wherein the user input corresponds to a designated zone within the image.

### BRIEF DESCRIPTION OF THE DRAWINGS

FIG. 1 is a schematic diagram illustrating an embodiment of a system for image segmentation of the invention;

FIG. 2 is a flowchart of image segmentation according to an embodiment of the invention;

FIG. 3A-3D are a schematic diagrams illustrating an example of designated zones in an image of the invention;

FIG. 4 is a flowchart of another embodiment of a method for segmenting foreground and background of an image of the invention; and

FIG. 5 is a schematic diagram illustrating an example of a locus in an image of the invention.

FIG. 6 is schematic diagram illustrating an another example of a locus in an image of the invention.

### DESCRIPTION

Methods and systems for foreground and background segmentation of an image and related applications are provided.

Conventional image segmentation methods, as described above, require complex computations of either focus variance comparison or object identification prior to pixel variance computation. In order to segment the foreground and background according to focus variance, camera has to shoot the same scene twice and the storage space required is doubled. The other conventional method takes two-step procedures, first object identification has to be performed for determining a contour, and then the edge of contour is performed with pixel variance comparison. The invention proposes a novel solution to avoid complex computations and takes benefit from the touch input of the handheld device.

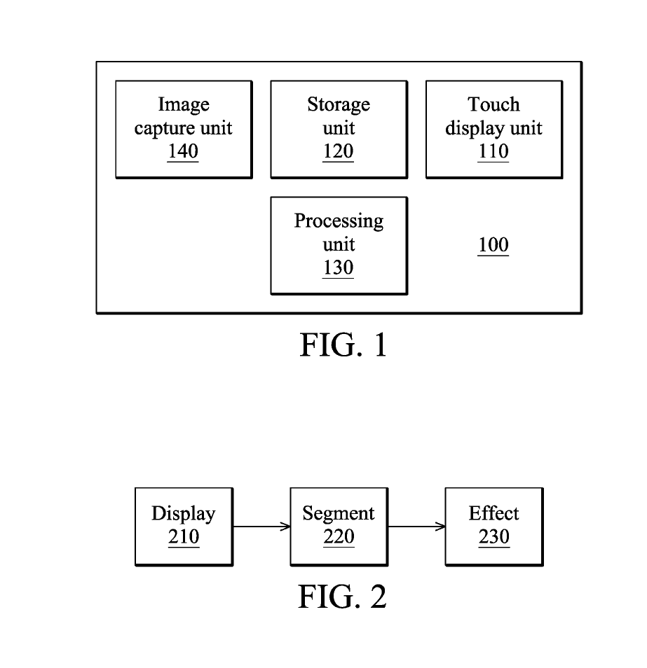

FIG. 1 is a schematic diagram illustrating an embodiment of a system for image segmentation of the invention. The image segmentation system can be used in an electronic device, such as PDA (Personal Digital Assistant), smart phone, mobile phone, MID (Mobile Internet Device, MID), laptop computer, car computer, digital camera, multi-media player, game console, tablet computer, or any other type of portable device. However, it should be understood that the invention is not limited thereto.

The image segmentation system 100 comprises a touch display unit 110, a storage unit 120, a processing unit 130 and an image capture unit 140. The touch display unit 110 is configured to display data, such as texts, figures, images, interfaces, and/or other information. The touch display unit 110 is also configured to receive inputs from the user. The touch display unit 110 may be a display unit integrated with a touch-sensitive device (not shown). The touch-sensitive device has a touch-sensitive surface comprising sensors in at least one dimension to detect contact and movement of at least one object (input tool), such as a pen/stylus or finger near or on the touch-sensitive surface. Accordingly, users are able to input commands or signals via the screen. The storage unit 120 comprises at least one image, wherein the image comprises a plurality of pixels. In some embodiments, the image can be stored in a database, such as photo album in the storage unit 120.

The image capture unit 140 is configured for capturing images. The image capture unit 140 may be a digital camera. It is known that digital camera generally provides auto focus function or manual focus setting. While shooting, the focus parameters can be saved for later use, such as focus length, focus aiming indicator, and/or others. In some embodiments, these parameters may be saved together with the images. For example, the focus parameters can be recorded in the EXIF header or metadata of the image file. The processing unit 130 is capable of performing image segmentation of the invention, which will be discussed further in the following paragraphs.

As can be known by one of ordinary skill in the art, the image capture unit 140 performs focus on foreground objects. These focus parameters could provide information about the foreground, and be used as a hint for image segmentation. For example, in the case that manual focus is enabled, user would tap on the face of a person. Therefore, the aiming indicator marks the position of the face of the person, which is a foreground object. In image segmentation process, face recognition need not be performed to identify the person. Instead, the aiming indicator provides a good starting point (seed pixels) to locate the person and a contour surround the person within the image.

Similarly, for the embodiment of using auto focus, the image capture unit 140 generally would search the center of focus, and display a cross suggesting so to the user. The focus parameter therefore provides good clue of the location of the person's face, and thus can be a starting point for doing image segmentation. By storing the focus parameters with the image eliminates the need of shooting the same scene in different focus and the focus variance comparison. There are significant benefits in memory saving and simplification of computations, and thus improves performance.

Please now refer to FIG. 2 in combination with FIG. 1. FIG. 2 is a flowchart of a method for image segmentation according to an embodiment of the invention. The method for image segmentation can be used in an electronic device, such as PDA, smart phone, mobile phone, MID, laptop computer, car computer, digital camera, multi-media player, game console, tablet computer, or any other type of portable device. However, it should be understood that the invention is not limited thereto.

First, the method starts by displaying an image and receiving at least one user input from the touch display unit 110, as shown in step S210. The image may be obtained for display from a database, such as photo album in the storage unit. In other embodiments, the image may be obtained from other storage media. For example, images can be downloaded from internet, transmitted by another external device, which may be a portable device, electronic device or storage device. Yet in another embodiment, the image may be obtained for display by an image capture process performed by the image capture unit 140. During the image capture process, user may provide input via the touch display unit 11, for example an aiming indicator corresponding to the face of a person or an object. The image may be stored with focus parameters that are used in the image capture process.

In one embodiment of the invention, the focus parameters may comprises focus length, focus aiming indicator, and/or others parameters suitable for segmentation. The focus parameters may be obtained in the image capture process and stored together or separately with the captured images. In addition, the focus parameters may be automatically calculated by the digital camera unit or provided according to user input via touch display unit 110.

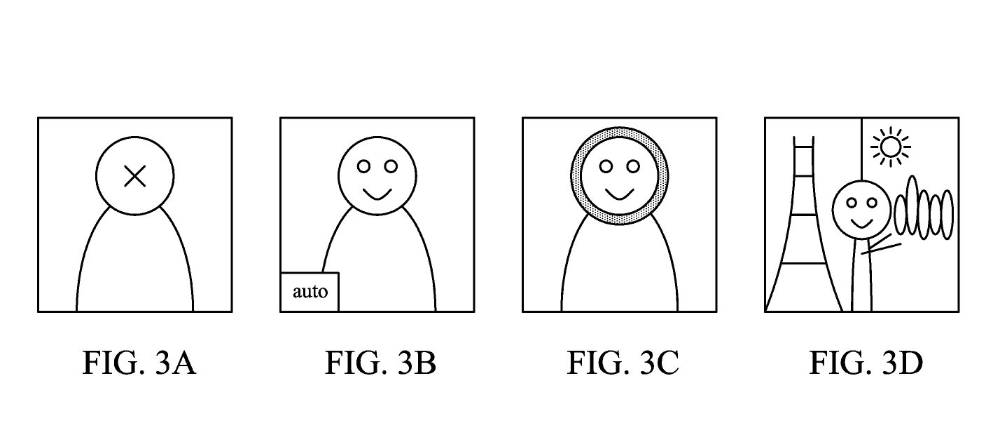

Also in step S210, user may provide inputs via the touch display unit 110 for instructing the processing unit 130 to perform image segmentation and/or other operations. In one embodiment of the invention, the method can be implemented as an application. An application interface may be provided on the touch display unit 110 for user to input instruction regarding image capture, image segmentation and/or other processes or settings. For the purpose of image capture process, the input may be an aiming indicator, auto focus enablement, and/or other focus related instructions. For the purpose of image segmentation process, the inputs may be a movement of an input tool forms a contour around an object, an indicator corresponding to an object, a contour surround an area, or an indicator corresponding to an area within the image. It should be understood by one of ordinary skill in the art that the movement may be continuous or discontinuous. For example, it may be a circle, cross, tap, and/or other suitable gesture. FIG. 3A illustrates an example of the movement of the input tool. As can be observed, the movement forms a contour around the face region.

The input for image segmentation process may correspond to an instruction of auto segmentation by using focus parameters obtained in the image capture process in another embodiment of the invention. For example, user may tap on the face of a person shown on the touch display unit, which is a focus aiming indicator as shown in FIG. 3B. The image capture unit 140 adjusts focus according to the tap input and captures the image. After the image is obtained, the user may input another instruction for auto segmentation via the touch display unit 100. In one embodiment of the invention, it can be provided as an option of the application interface as shown in FIG. 3C.

Step S220 performs an image segmentation on the image according to the at least one user input. The processing unit 130 may perform image segmentation by a predefined algorithm. In one embodiment of the invention a graph-cut algorithm can be used to perform the segmentation, while in another embodiment a watershed algorithm can be used to perform the segmentation. Please note that above algorithms are simply illustrated as examples and the invention is not limited thereto. In the embodiment of FIG. 3A, the image segmentation may be performed by determining the face region of the image according to the contour form by movement input.

It should be understood that in the embodiments illustrated above, the at least one input may correspond to a designated zone with the image. Either the focus aiming indicator or movement can be used to determine a region or an object. In the embodiments of FIG. 3A-3B, for example, the at least one input correspond to the face region of a person. The designated zone may define a contour of an object/person, a selected region within the image, and/or other geographic topology calculated by the portable device. Also the at least one designated zone may be a closed region or with open edge. It should be understood that, the position and/or size of the designated zone can be adjusted, for example, via a touch display unit by using an input tool, such as a stylus, touch pen or a finger.

And last step 230 applies a visual effect on the image according to the result of image segmentation. The visual effect may be implemented by replacing part of the segmented region with one or more images. Or the visual effect may change shape or appearance of a segmented region. Again in the embodiments of FIG. 3A-3C, the face region, or say foreground, can be segmented and reserved, while the other region, or say background, can be replaced with a serious of images displayed as a slid show. For example, the back ground can be replaced by images of famous landmarks, which creates the effect that the person captures images at these places as illustrated in FIG. 3D.

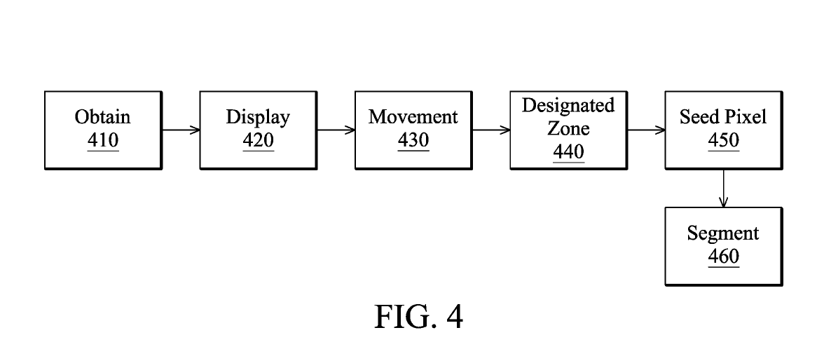

FIG. 4 illustrates flowchart of an image segmentation method according to another embodiment of the invention. The image segmentation method can be used in an electronic device, such as PDA, smart phone, mobile phone, MID, laptop computer, car computer, digital camera, multi-media player, game console, tablet computer, or any other type of portable device. However, it should be understood that the invention is not limited thereto. In this embodiment, a movement on the touch display unit can be used for automatic image segmentation.

First, in step s410 an image is obtained, in which comprises a plurality of pixels. The image can be obtained from a database, such as photo album in the storage unit, or from an image capture process, such as a photographing procedure. In step S420, the image is displayed on a touch display unit 110. In step S430, a movement of an input tool on or nearby the touch display unit 110 is detected. The movement may form a contour around an object or area, an indicator corresponding to an object or area, a contour surround an object or area, or an indicator corresponding to an object or area within the image. It should be understood by one of ordinary skill in the art that the movement may be continuous or discontinuous.

Then in step S440 a designated zone within the image corresponding to the movement is determined. It should be understood that the designated zone may form a closed zone or open zone. If the movement on the touch display unit forms an open zone, an edge detection technique can be applied thus to automatically generate a closed zone corresponding to the designated zone. In the case that the movement does not form a closed zone but reaches at least one boundary of the image, a closed zone can be automatically generated according to the designated zone and the at least one boundary of the image.

The designated zone may define a contour of an object/person, a selected region within the image, and/or other geographic topology. Also the at least one designated zone may be a closed region or with open edge. The at least one seed pixel are obtained from pixels of the contour of the designated zone. In one embodiment, the seed pixels may be pixels located on the outer or inner ring of the designated zone. Or in another embodiment, the seed pixels may be selected as those with most significant features.

After the designated zone is determined, at least one seed pixel is obtained according to the designated zone in step S450. The at least one seed pixel can be obtained from pixels on the inner/outer edge of the designated zone. For example, the seed pixels can be pixels located on the outer edge of designated zone and are within a predetermined distance to the envelope (outer most edge) of the designated zone. In another embodiment, the seed pixels can be pixels nearby the outer edge or the inner edge of the designated zone.

In step S460, the image is segmented to obtain at least one segmented region. The segmentation may be performed by using a predefined algorithm based on the at least one seed pixel. In some embodiments, a graph-cut algorithm can be used to perform the segmentation based on the seed pixels. In other embodiments, a watershed algorithm can be used to perform the segmentation based on the seed pixels. It should be understood that above algorithms are only provided as examples, and the invention is not limited thereto.

Once the segmentation is done, users may utilize the result of foreground/background segmentation for other applications. In step S470 the at least one segmented region is replaced with at least one second image for creating special visual effect. For example, user may replace original background with other background images. Background images can be pre-stored in a storage unit or other storage media, and replaced in a predefined order. For example, a first background image is displayed with the original foreground for 3 seconds, then later switch to a second background image for another 3 seconds and so on. In another example, the background images may be switched in fade-in-fade-out fashion. The direction of fade-in-fade-out can be one dimensional or multi-dimensional. Yet in another example, the background image itself may be applied morphing effect for creating different looks by use of single background. Similarly, the foreground image can be switched, replaced or morphed so as to create various visual effects.

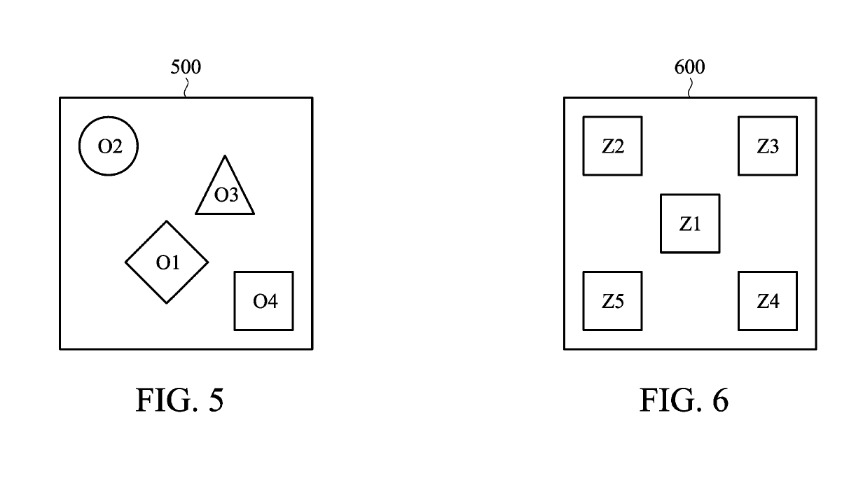

FIG. 5 and FIG. 6 demonstrate embodiments of correspondence between movements of input tools and corresponding designated zones. As shown in FIG. 5, an image 500 can be displayed on the touch display unit, and the user can move his finger to form a contour for selecting object O1 in the image 500. After the image segmentation, object O1 can be segmented as the foreground of the image 500, and the remaining part of the image 500, such as objects O2, O3 and O4 can be segmented as the background of the image 500.

In the embodiment of FIG. 6, the designated zone can be predefined by user or by device default setting for automatic segmentation. For example, designated zone Z1 located at center region can be a foreground region determined according to the focus parameter, the human body model, and/or the detection result of the face detection for the image. Additionally, designated zones Z2, Z3 and Z4 can be the background zone set at the corner of the image 300. The selection of designated zone corresponding to foreground or background may depend on the actual need, construction of the image, user designation, and or the other factors. For example, it could be the center region of the image where the face of a person is usually illustrated. In another embodiment, the touch display unit can be provided as an input for the user to select or modify the designated region.

It should be understood that the at least one designated zone can be classified as foreground region and/or background region. For example, the at least one designated zone corresponds to a foreground region in the case that the designated zone is determined by face detection mechanism. In the case that the at least one designated zone is determined, for example at corner of the image, the designated zone may correspond to background region of the image. It should be noted that the foreground and/or background may comprise one or more regions, such as for images having multiple people, or in a scene with multiple small objects behind the subject of the image.

In addition, after the segmented region is obtained from the image, a subsequent movement of the input tool on the touch display unit can be further detected. Similarly, a second designated zone corresponding to the subsequent movement can be obtained. The second designated zone can be also mapped to the image to obtain at least one second seed pixel from the image. Similarly, the at least one second seed pixel is obtained on or nearby the edge of the second designated zone. Based on the at least one second seed pixels, the second segmented region can be obtained. In some embodiments, a plurality of instructions, such as an add instruction, a modify instruction and a remove instruction can be provided by the user and displayed on the touch display unit. Users can select one of the instructions for addition, modification or removal to reshape the designated zones. Once an instruction is received, the seed pixels can be added to or removed based on the instruction.

Therefore, the methods and systems for image segmentation and related applications can segment foreground and background of an image according to focus parameter, and/or based on the movement on the touch display unit. Embodiments of the invention can be implemented in the form of a program code (i.e., executable instructions) embodied in tangible media, such as floppy diskettes, CD-ROMS, ROM, RAM, hard drives, or any other machine-readable storage medium. The program code is loaded into and executed by a machine, such as a portable device, the machine thereby becomes an apparatus for practicing the methods. The program code may embodied as an application software, and be distributed by download, install and/or other proper ways. The methods may also be embodied in the form of a program code transmitted over some transmission medium, such as electrical wiring or cabling, through fiber optics, or via any other form of transmission. The program code is received, loaded into and executed by a machine, such as a portable device, the machine becomes an apparatus for practicing the disclosed methods. When implemented on a general-purpose processor, the program code combines with the processor to provide a unique apparatus that operates analogously to application designated logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A method for image segmentation applied in a portable device having a touch display unit, comprising:
obtaining an image;
display the image on the touch display unit;
detecting a movement of an input tool on the touch display unit;
determining a designated zone within the image corresponding to the detected movement; and
segmenting the image according to the designated zone to obtain at least one segmented region;
wherein the at least one segmented region corresponds to one of the following: a foreground part of the image and a background part of the image.

2. The method according to claim 1, further comprises:
obtaining at least one seed pixel according to the designated zone; and
segmenting the image by using a predefined segmentation algorithm based on the at least one seed pixel.

3. The method according to claim 2, wherein the at least one seed pixel is obtained from pixels in any combination of the following: pixels on the edge of the designated zone, pixels surround the edge of the designated zone, and pixels nearby the edge of the designated zone.

4. The method according to claim 1, wherein the determining of the designated zone comprises:
performing an edge detection in response to the designated zone is not closed;
reforming the designated zone into closed.

5. The method according to claim 1, further comprises replacing the at least one segmented region with at least one second image, wherein the at least one second image is selected from the following: database in a storage unit of the portable device, images received from an external electronic device, images retrieved via wireless transmission.

6. The method according to claim 5, wherein the replacing of the at least one segmented region is implemented in one of the following:
switching a plurality of the second images in a slide show fashion;
fading in and fading out of the at least one second image in a predetermined order; and
morphing of the at least one second image.

7. The method of claim 1, wherein the movement of the input tool forms one of the following: a contour around an object, an indicator corresponding to an object, a contour surround a background area, and an indicator corresponding to a background area.

8. The method of claim 1, further comprising:
receiving an instruction from the touch display unit; and
modifying the designated zone according to the instruction;
wherein the modifying comprises addition, deletion and reshaping.

9. A system for executing an image segmentation application in a portable device, comprising:
a touch display unit, configured to display an image and to receive at least one user input corresponding to the image; and
a storage unit, configured to store the image; and
a processing unit, configured to execute the image segmentation application according to the at least one user input, wherein the image segmentation application performs: determination of a designated zone within the image according to the user input, image segmentation to obtain a segmented region corresponding to the designated zone, and visual effect on the image with respect to the segmented region.

10. The system of claim 9, wherein the user input is a movement by a user on the touch display unit and defines a contour of the designated zone.

11. The system of claim 10, wherein the processing unit modifies the designated zone into closed in response to the designated zone is open.

12. The system of claim 9, wherein the processing unit is further configured to determine the designated zone according to the user input and at least one parameter; the user input instructs an automatic determination of the designated zone, and the at least one parameter is one of the following: a focus parameter obtained from the storage unit, a parameter specifying a predefined region within the image, the predefine region is a center region or a corner region.

13. The system of claim 9, wherein the visual effect comprises replacement of remaining region within the image with a second image in response to the segmented region is a foreground; and the visual effect is in the form of slide show, fade-in-fade-out, or morphing.

14. The system of claim 13, wherein the second image is obtained from the storage unit of the portable device, an external device, or via wireless transmission.

15. The system of claim 9, further comprising a digital camera unit configured to capture the image according to the at least one user input, store the image and at least one parameter corresponding to the at least one user input, wherein the at least one parameter comprises focus information.

16. A method for image segmentation applied in a portable device having a touch display unit, the method comprising:
displaying an image and receiving at least one user input from the touch display unit;
performing an image segmentation on the image according to the at least one user input; and
applying a visual effect on the image according to the result of image segmentation;
wherein the user input corresponds to a designated zone within the image.

17. The method of claim 16, further comprising:
capturing the image according to the at least one user input; and
storing the image and at least one parameter corresponding to the at least one user input;
wherein the at least one parameter comprises focus information, and the designated zone corresponds to a foreground part of the image.

18. The method of claim 16, wherein the performing of image segmentation comprises:
applying a predetermined algorithm to determine the designated zone according to the user input; and
segmenting the designated zone from remaining region of the image.

19. The method of claim 18, wherein the applying of visual effect comprises:
reserving the designated zone of the image;
replacing the remaining region of the image with a second image; and
displaying the designated zone and the second image on the touch display unit.

20. The method of claim 16, wherein the applying of visual effect comprises:
segmenting the designated zone from the image;
replacing the designated zone with a second image; and
displaying the segmented image and the second image on the touch display unit.
